(19) United States
(12) Patent Application Publication
(10) Pub. No.: US 2025/0265443 A1
(43) Pub. Date: Aug. 21, 2025

(54) SYSTEMS AND METHODS FOR BUILDING TASK-ORIENTED HIERARCHICAL AGENT ARCHITECTURES

(71) Applicant: Salesforce, Inc., San Francisco, CA (US)

(72) Inventors: Zhiwei Liu, Palo Alto, CA (US); Weiran Yao, San Francisco, CA (US); Jianguo Zhang, San Jose, CA (US); Liangwei Yang, Palo Alto, CA (US); Zuxin Liu, Palo Alto, CA (US); Juntao Tan, Palo Alto, CA (US); Prafulla Kumar Choubey, San Jose, CA (US); Tian Lan, Palo Alto, CA (US); Chien-Sheng Wu, Mountain View, CA (US); Huan Wang, Palo Alto, CA (US); Shelby Heinecke, San Francisco, CA (US); Caiming Xiong, Menlo Park, CA (US); Silvio Savarese, Palo Alto, CA (US)

(21) Appl. No.: 18/738,984

(22) Filed: Jun. 10, 2024

Related U.S. Application Data
(60) Provisional application No. 63/555,382, filed on Feb. 19, 2024.

(51) Int. Cl. G06N 3/04

(52) U.S. Cl. CPC G06N 3/04

(57) ABSTRACT

Embodiments described herein provide a method for building a hierarchical structure of a plurality of neural network models for performing a task. The method includes the following operations. A task instruction is received via a data interface. A first neural network model generates a first sub-task from the task instruction. A second neural network model is selected from the plurality of the neural network models based on the first sub-task. A first connection is built via a first API, between the first neural network model and the second neural network model. The first neural network model generates a first sub-task package in a format compliant with the second neural network model. A first output is received via the first connection from the second neural network model that executes the first sub-task package. The first neural network model generates a second sub-task based on the task instruction and the first output.

### CROSS REFERENCE(S)

The instant application is a nonprovisional of and claim priority under 35 U.S.C. 119 to U.S. provisional application No. 63/555,382, filed Feb. 19, 2024, which is hereby expressly incorporated by reference herein in its entirety.

### TECHNICAL FIELD

The embodiments relate generally to machine learning systems for autonomous agents, and more specifically to building task-oriented hierarchical agent architectures.

### BACKGROUND

Machine learning systems have been widely used in autonomous agents. For example, an autonomous agent may be queried as to a next action to perform in pursuit of a specific task, such as to book travel plans, to trouble shoot Information Technology (IT) issues, and/or the like. Large language models (LLMs) may be utilized to provide an agent response and/or reasoning, referred to as LLM-augmented Autonomous Agents or agents. However, an agent may have limited capability to solve complex tasks.

Therefore, there is a need for building an agent architecture capable of solving complex tasks.

### BRIEF DESCRIPTION OF THE DRAWINGS

FIGS. 1A-1E provide example block diagrams illustrating various exemplary architectures of hierarchical LLM agents, according to some embodiments.

FIG. 2 is a simplified diagram illustrating a computing device implementing the agent building framework described in FIGS. 1A-1E, according to some embodiments.

FIG. 3 is a simplified diagram illustrating a neural network structure, according to some embodiments.

FIG. 4 is a simplified block diagram of a networked system suitable for implementing the agent building framework described in FIGS. 1A-1E and other embodiments described herein.

FIG. 5 is an example logic flow diagram illustrating a method of building hierarchical agent architectures based on the framework shown in FIGS. 1A-1E, according to some embodiments.

FIG. 6 illustrates pseudo codes for initializing an individual agent and a manager agent, according to some embodiments.

FIGS. 7A and 7B illustrate various applications of the hierarchical agent architectures, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

Artificial intelligent (AI) agents may be used to interact with users and generate an output to perform a task. For example, such AI agents may be implemented through one or more LLMs that perform language tasks based on a user utterance, such as “can you organize the sales data from last year.” However, when the AI agent receives a complex task input, such as “help me book a trip to Tokyo from March 12 to March 19” that likely entail a series of different type of tasks (e.g., booking flights, hotels, restaurant reservations, local driving navigation, etc.), a single LLM agent may find it challenging to encompass all tasks needed for the task input.

In view of the need for LLM agents to solve complex task requests, embodiments described herein provide systems and methods for building a hierarchical architecture comprising multiple agents to jointly solve a complex task. The hierarchical architecture includes a manager agent and a plurality of individual agents that may be remotely accessible by the manager agent. Each of the individual agents may be optimized for a particular function, either through fine-tuning the underlying LLM itself or optimizing a particular prompt for the underlying LLM. The manager agent is configured to communicate with each of the individual agents and manages task assignment amongst the individual agents. For example, the manager agent can receive a task instruction from a user, decompose the task instruction into sub-tasks, determine which individual agent should handle a particular sub-task, and generates a sub-task package to send to the individual agent. The individual agent, after completing the sub-task, can send a response back to the manager agent reflecting the result of the task assignment. The manager agent can then progressively determine a next-step sub-task and repeat the sub-task assignment process.

Embodiments described herein provide a number of benefits. By selecting LLM agents and building an architecture of LLM agents to jointly complete a complicated task from a user, the hierarchical agent architecture can thus solve a complex task effectively and efficiently, with minimum or none computational overhead to train or finetune a language model for a particular type of task or on a particular type of domain. Therefore, the efficiency in computational complexity improves neural network technology in designing and deploying AI agents.

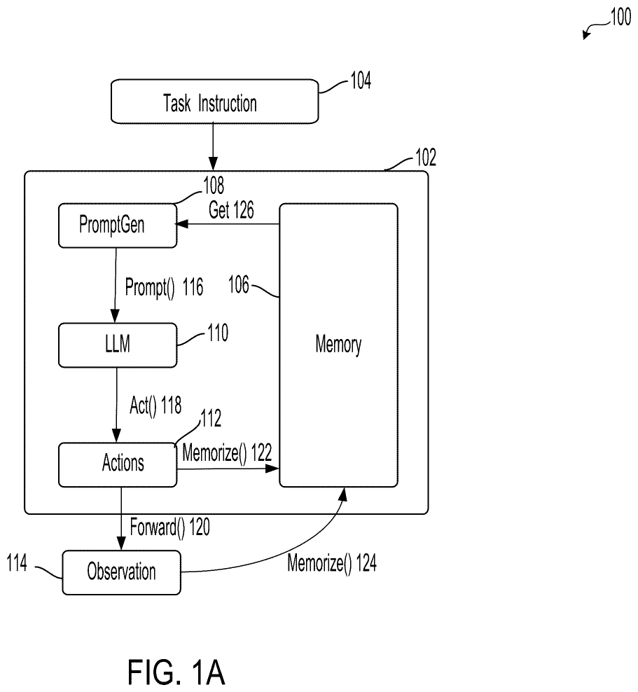

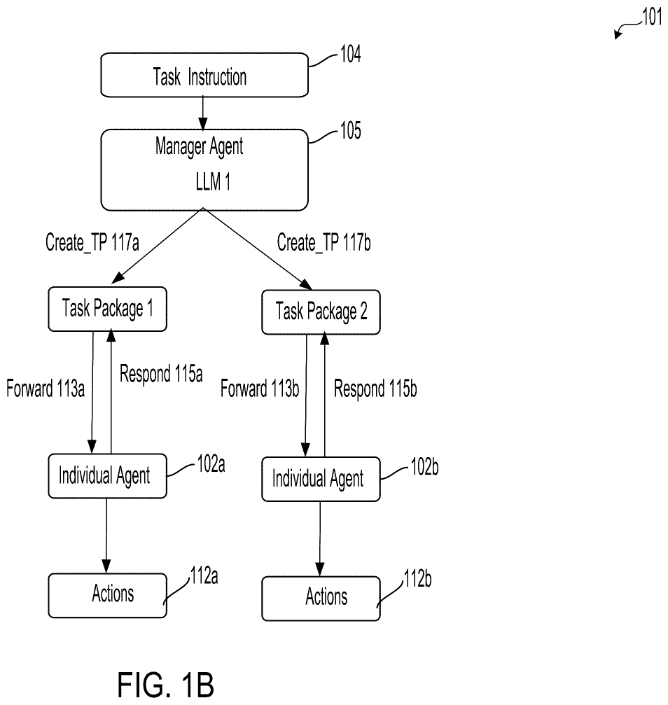

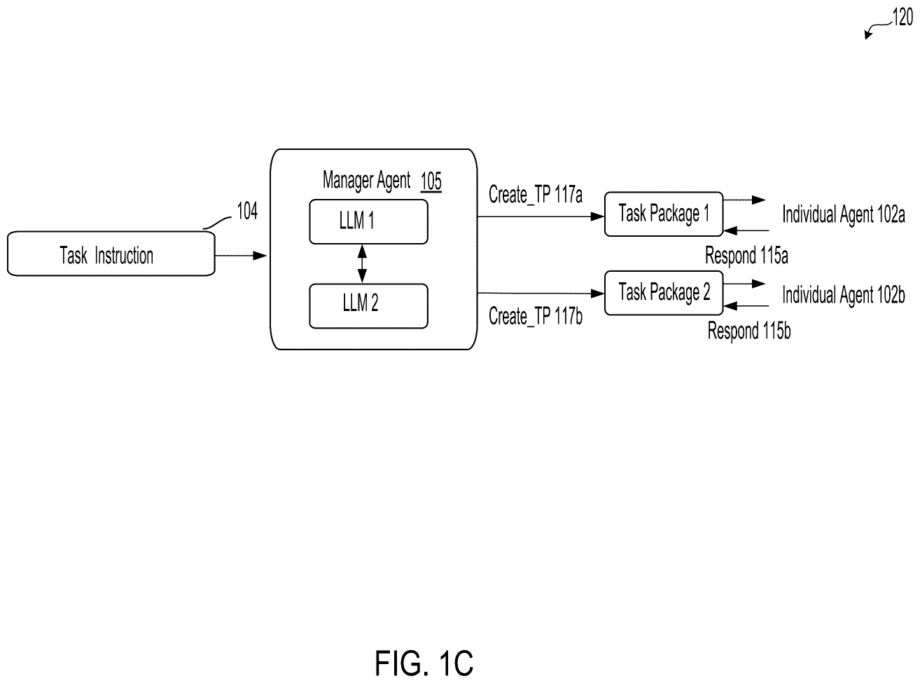

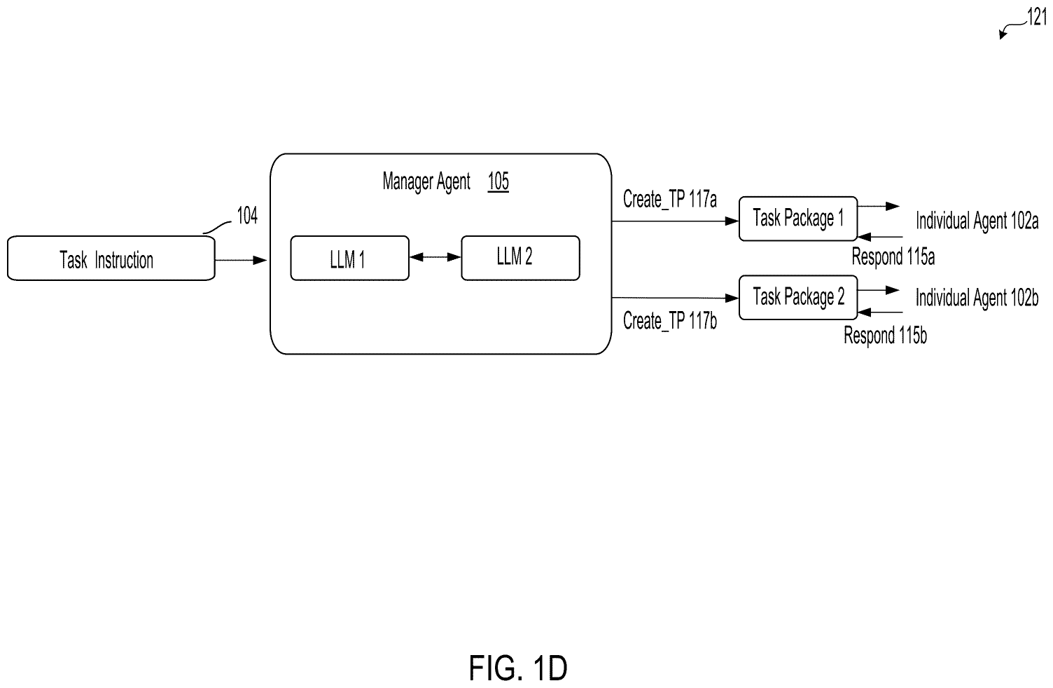

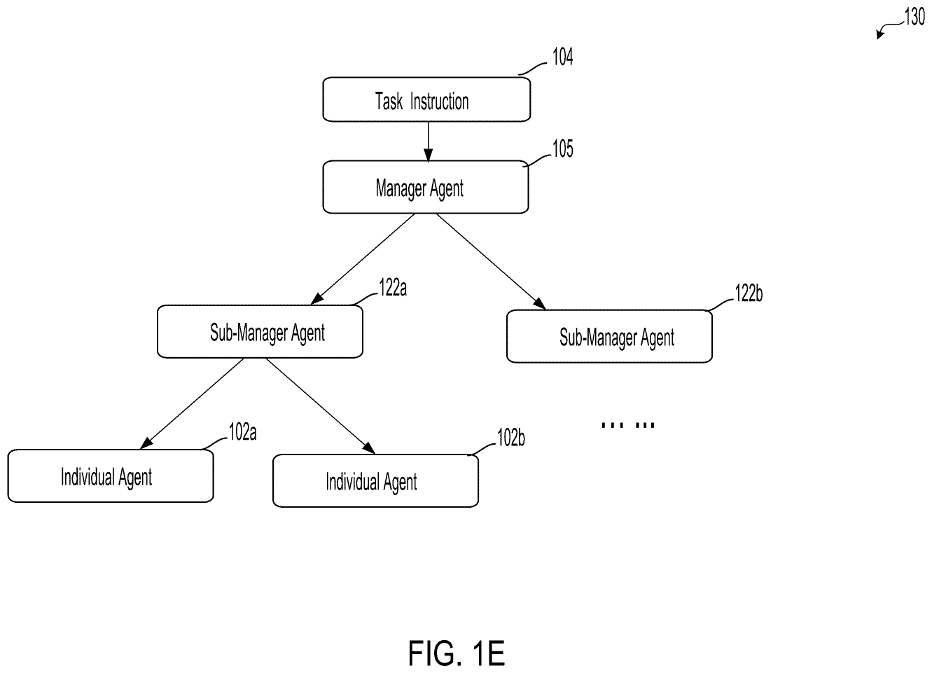

FIGS. 1A-1E provide example block diagrams illustrating various an exemplary architectures of hierarchical LLM agents, according to some embodiments. FIG. 1A is a simplified diagram illustrating an architecture 100 of an individual agent 102, according to some embodiments of the present disclosure. Individual agent 102 may include a controller that includes a prompt generation module (PromptGen) 108, an LLM module 110, an actions module 112, and a memory module 106. The controller may receive a task instruction 104 from a user and execute actions by action module 112 on an environment surrounding individual agent 102, in an attempt to complete the task indicated by task instruction 104. For example, the environment may be a web browser interface which is able to navigate websites, and interact with them by selecting buttons/links and filling in text fields. Task instruction 104 may be “buy an electric guitar”. Based on task instruction 104, the controller may perform action 118 such as “[URL] Amazon.com”, “[Search] Electric guitar”, “[Click] item (1)”, “[Click] Checkout”, etc. The format of the actions generated by the controller may be in a format which is acceptable to the environment. In the list of actions above, for example, the type of action is in brackets, and the specific button to click or text to enter follows the bracketed indicator. Other formats may be used depending on the environment. For example, the environment may further comprise an application programming interface (API) which may control a variety of software programs and/or physical hardware components, each with a particular set of available actions.

In some embodiments, the prompt generation module 108 generates a prompt 116 based on task instruction, for LLM module 110 to generate an action 118 as the output. Prompt generation module 108 may construct prompt 116 based on one or more elements such as agent role description, task instruction 104, constraints for prompt generation, agent actions, examples, etc. In some embodiments, the one or more elements are combined for the generation of prompt 116.

In some embodiments, LLM module 110 includes a LLM that generates action 118. In various embodiments, the LLM may be situated in the same server as the controller or in a remote server. The controller may be communicatively connected to the LLM (or LLM module 110) via an API. For example, prompt 116 may be sent to the LLM via the API.

In some embodiments, actions module 112 parses action 118 and executes action 118. In some embodiments, each action is defined with a name, a description, and certain parameters. The controller memorizes 122 the executed actions into memory module 106. The controller also forwards 120 the actions to the environment to obtain an observation 114, which is then stored in memory module 106.

After actions module 112 executes action 118, the environment may provide updated information about the state of the environment via observation 114, communicated to the controller. The state may include, for example, available actions (e.g., buttons/links and text entry fields). For some environments, actions may include physical processes such as controlling a robotic arm, adjusting physical parameters that may be defined over observed or predetermined ranges, etc. Observation 114 of a state of the environment may also include other information besides available actions such as error messages, text output, images displayed by the environment, etc. Observation 104 may be stored in memory module 106.

In some embodiments, memory module 106 stores the observation 114 (e.g., action-based observations chains of individual agent 102) and historical actions of individual agent 102. In some embodiments, prompt generation module 106 obtains/gets 126 its historical actions and corresponding observations, which are concatenated and input to the prompt generation module 108 to generate prompt 116. The generated action 118 and returned observations 114 are then memorized 124 (or saved) into memory module 106. In various embodiments, memory module 106 may also be stored with various operations of individual agent 102.

For example, task instruction 104 may be “buy an electric guitar”. The first prompt 116 to LLM module 110 may be generated solely based on the task instruction 104 and a predetermined prompt template. The prompt template may describe the purpose of LLM module 110 in determining actions to be performed on an environment, and may describe the expected types of actions that may be performed on the environment. Task instruction 104 may be appended or otherwise included in the predefined template prompt to provide prompt 116. Action 118 generated by LLM module 110, may be “[URL] Amazon.com”. The resulting observation 114 may be a description of the Amazon.com website including which links are available and which text fields are available, including the search bar. This observation 114 may be stored in memory 106. Prompt 116 may be updated to include the first action taken and the resulting observation 114 in addition to the prompt template and task instruction 104. Based on this updated prompt 116, LLM module 110 may generate a next action, for example “[Search] Electric guitar”. This process may continue to iterate with additional actions executed by actions module 112 and observations 104 until the task is complete. The controller may determine the task is complete. For example, after each observation 114, a neural network based model (e.g., LLM module 110) may be given a prompt asking whether the observation 114 represents the completion of the task described in task instruction 104. In some embodiments, LLM module 110 indicates a generated action is the final action required, rather than determining based on a final observation 114.

In some embodiments, individual agent 102 functions as the base agent or level-1 agent of a hierarchical agent architecture. For example, individual agent 102 may be optimized in one or more functions/actions that are part of the task provided by task instruction 104. In some embodiments, in a hierarchical agent architecture, individual agent 102 is selected and/or controlled by a manager agent, which centralizes the task assignment and control such that the solving of task instruction 104 is more effective.

A hierarchical agent architecture may include at least two levels of agents, e.g., one or more manager agents and a plurality of individual agents. FIGS. 1B-1D shows different configurations of two-level hierarchical agent architectures. FIG. 1B illustrates a hierarchical agent architecture 101 that includes a manager agent 105 and a plurality of individual agents 102a and 102b, according to some embodiments. Manager agent 105 may decompose a task into sub-tasks, select individual agents based on the sub-tasks, and send the sub-tasks to the corresponding individual agents to complete. In some embodiments, each individual agent is referred to as one type of action of manager agent 105 when adding to the team of this manager agent 105.

In some embodiments, manager agent 105 has a similar architecture as individual agent 102. For example, manager agent 105 has a controller that includes a prompt generation module, an LLM module, and a memory module. The prompt generation module may generate a prompt based on task instruction 104, any feedback/response message from the previous individual agent, and/or previous actions, to generate a sub-task. In some embodiments, the LLM module includes a LLM (e.g., LLM 1), which is connected to the controller of manager agent 105 via an API. The LLM module may generate the sub-task, upon receiving the prompt, and send the sub-task back to the controller via the API. The controller may then select a next individual agent based on the sub-task. The controller of manager agent 105 may build a communicative connection with the selected individual agent such that the LLM module of manager agent 105 can communicate with the LLM module of the selected individual agent. In some embodiments, the prompt generation module of manager agent 105 may generate another prompt that causes the LLM module of manager agent 105 to generate a task package based on the sub-task, and transmit the task package to the selected individual agent via the respective API. The memory module of manager agent 105 may store response messages/feedback from previous individual agents, previous sub-tasks, previous actions, etc.

As shown in FIG. 1B, manager agent 105 may receive task instruction 104 from a user. Manager agent 105 may decompose task instruction 104 and generate a first sub-task from task instruction 104. In some embodiments, the first sub-task may be part of the entire task described in task instruction 104, and the completion of the first sub-task may require one or more actions. The controller of manager 105 may select an individual agent 102a from a plurality of available individual agents capable of a variety of functions, and build a communication connection with individual agent 102a via a respective API. The controller of manager agent 105 may then create a task package 1 (create_TP 117a) corresponding to the first sub-task, and may forward 113a task package 1 to individual agent 102a. The task package 1 may be the input to individual agent 102a, and may cause individual agent 102a to generate an action, which is executed by the respective actions module 112a. In some embodiments, task package 1 includes a prompt compliant with individual agent 102a (or the LLM of individual agent 102a). The prompt may instruct individual agent 102a (or the LLM of individual agent 102a) to perform the first sub-task. The execution of an action by individual agent 102a may be referred to the description of individual agent 102, and is not repeated herein.

After the execution of task package 1, individual agent 102a may then respond to manager agent 105 by transmitting a response message 115a. In some embodiments, response message 115a includes one or more of a completion status of the first sub-task, identification information for individual agent 102a (or the LLM of individual agent 102a), or identification information for manager agent 105, etc. In some embodiments, response message 115a includes a response template for manager agent 105 to populate a response and/or an output of the first sub-task.

Upon receiving response message 115a from individual agent 102a, manager agent 105 (or the LLM module of manager agent 105) may generate a second sub-task based on response message 115a and task instruction 104. In some embodiments, second sub-task may be another part of the entire task provided by task instruction 104, and may be different from the first sub-task. Similarly, the controller of manager 105 may select another individual agent 102b from the plurality of available individual agents capable of a variety of functions, and build another communication connection with individual agent 102b via a respective API. Manager agent 105 (or the LLM module of manager agent 105) may then create a task package 2 (create_TP 117b) corresponding to the second sub-task, and may forward 113b task package 2 to individual agent 102b. The task package 2 may be the input to individual agent 102b, and may cause individual agent 102b to generate an action, which is executed by the respective actions module 112b. In some embodiments, task package 2 includes a prompt compliant with individual agent 102b (or the LLM of individual agent 102b). The prompt may instruct individual agent 102b (or the LLM of individual agent 102b) to perform the second sub-task.

In some embodiments, individual agent 102b then responds to manager agent 105 by transmitting a response message 115b after the execution of task package 2. In some embodiments, response message 115b includes one or more of a completion status of the second sub-task, identification information for individual agent 102b (or the LLM of individual agent 102b), and identification information for manager agent 105, etc. In some embodiments, response message 115b includes a response template for manager agent 105 to populate a response and/or an output of the second sub-task.

In various embodiments, manager agent 105 may select a plurality of individual agents to complete different actions/functions of the entire task described in task instruction 104. For example, manager agent 105 may select a third individual agent based on response message 115b and cause the third individual agent to complete a third sub-task, and so on. In various embodiments, manager agent 105 may select any suitable number of individual agents for its team to solve the entire task. Manager agent 105 may generate a sub-task based on the feedback/response message from the previous individual agent, and select a next individual agent based on the sub-task. The specific number of individual agents in hierarchical agent structure 101 is not limited by the embodiments of the present disclosure.

In some embodiments, a task package (e.g., task package 1, task package 2, . . . , etc.) may serve as a communication basis between manager agent 105 and an individual agent (e.g., 102a, 102b, . . . , etc.) in its team. Manager agent 105 may generate and delegate sub-tasks to the individual agents via task packages. A task package includes a prompt that is compliant with the corresponding individual agent, and can cause the individual agent to generate an action to solve the sub-task corresponding to the task package. Upon receiving a sub-task, a designated agent (e.g., individual agent) is responsible for solving this sub-task and subsequently communicating with outcome/feedback back to manager agent 105. This modular approach facilitates the assembly of a multi-agent system, which may incorporate multiple specialized agents (e.g., individual agents) under the supervision of a manager agent to address complex tasks that require diverse actions. Harnessing the collective capabilities of its components enhances its efficiency and bring more potential to a scalable multi-agent system. In some embodiments, the generation of task packages follows a sequential order, which the creation of a subsequent task package predicted on the feedback received from the execution of its predecessor. The sequential process may increase the system's ability to dynamically adapt and respond to the evolving requirements of the initial task.

In some embodiments, a manager agent 105 includes a LLM module that includes a plurality of LLMs configured to jointly generate a sub-task based on any response message and task instruction 104. The LLMs may be communicatively coupled to one another in various suitable configurations such as parallel, sequential, or a combination of both. FIG. 1C shows a hierarchical agent structure 120 in which manager agent 105 includes a LLM module 1 and a LLM module 2, according to some embodiments. LLM1 and LLM2 may be communicatively coupled with the controller of manager agent 105 via respective API's, and may be communicatively coupled with one another via one or more API's. In some embodiments, LLM 1 and LLM 2 may be coupled to each other in a parallel configuration. LLM 1 and LLM 2 may jointly generate a sub-task based on task instruction 104 and a response message from an individual agent.

For example, the controller of manage agent 105 may create (create_TP 117a) and send task package 1 (corresponding to a first sub-task of the entire task described in task instruction 104) to individual agent 102a and receive a response message (respond 115a) from individual agent 102a, referring to the description of FIG. 1B. The controller of manager agent 105 may then generate prompts for each of LLM 1 and LLM 2 based on the response message and task instruction 104. LLM 1 and LLM 2 may each receive the respective prompt, task instruction 104, and the response message (e.g., via the respective API). The prompts may cause LLM 1 and LLM 2 to respectively generate a first part and a second part of the entire task described by task instruction 104. In some embodiments, the first part is different than the second part, of the entire task. One of LLM 1 and LLM 2 may assemble the first part and the second part of the entire task to generate a second sub-task of the entire task. The controller of manager agent 105 may select individual agent 102b based on the second sub-task, and may create a task package (create_TP 117b) for individual agent 102b.

FIG. 1C shows another hierarchical agent structure 121 in which manager agent 105 includes a LLM module 1 and a LLM module 2, according to some embodiments. LLM1 and LLM2 may be communicatively coupled with the controller of manager agent 105 via respective API's, and may be communicative coupled to one another via one or more API's. In some embodiments, LLM 1 and LLM 2 may be coupled to each other in a sequential configuration. LLM 1 and LLM 2 may jointly generate a sub-task based on task instruction 104 and a response message from an individual agent.

For example, the controller of manage agent 105 may create (create_TP 117a) and send task package 1 (corresponding to a first sub-task of the entire task described in task instruction 104) to individual agent 102a and receive a response message (respond 115a) from individual agent 102a, referring to the description of FIG. 1B. Manager agent 105 may generate a prompt for LLM 1 based on the response message and task instruction 104. The prompt may cause LLM 1 to generate an initial second sub-task as part of the entire task described by task instruction 104 based on task instruction 104 and the response message via its API. Manager agent 105 may also generate, based on the initial second-sub-task, a prompt for LLM 2 to cause LLM 2 to generate the second sub-task. In some embodiments, LLM 2 may generate the second sub-task based on task instruction 104 and the response message (and optionally the initial second sub-task), via its respective API. The controller of manager agent 105 may select individual agent 102b based on the second sub-task, and may create a task package (create_TP 117b) for individual agent 102b.

A hierarchical agent architecture may also include more than two levels of agents. In some embodiments, a manager agent can select a sub-manager agent that further selects an individual agent. For example, a hierarchical agent structure may include one or more manager agents, one or more sub-manager agents, and a plurality of individual agents. FIG. 1E shows a hierarchical agent architecture 130 that has manager agent 105, sub-manager agents 112a and 112b, and individual agents 102a and 102b. For ease of illustration, additional individual agents communicatively coupled to sub-manager agent 122b are not shown in FIG. 1E. In some embodiments, sub-manager agents 112a and 112b each has a similar architecture as manager agent 105, and is configured to select individual agents. In some embodiments, sub-manager agents 112a and 112b each includes a prompt generation module, a LLM module, and a memory module. The LLM module of a sub-manager agent is communicatively coupled to an individual agent via a respective API, and the LLM of a manager agent is communicatively coupled to a sub-manager agent via a respective API.

The controller of manager agent 105 may generate a first sub-task based on task instruction 103, similar to those described in FIGS. 1B-1D. The controller of manager agent 105 may select a sub-manager agent 122a, amongst a plurality of sub-manager agents, based on the first sub-task and send the first sub-task to sub-manager agent 122a. The controller of sub-manager agent 112a may further decompose the first sub-task to generate another first sub-task (via its prompt generation module and LLM module), which is part of the first sub-task. Sub-manager agent 112a may select individual agent 102a, amongst a plurality of individual agents, based on the other first sub-task. The controller of sub-manager agent 122a may establish/build a connection with individual agent 102a via a respective API, generate a task package corresponding to the other first sub-task, and send the task package to individual agent 102a for execution. In some embodiments, the task package includes a prompt that is compliant with individual agent 102a, and can cause individual agent 102a to generate an action to solve the other first sub-task. After the task package is completed by individual agent 102a, sub-manager agent 122a may receive a response message from individual agent 102a, and generate another second sub-task based on the response message and the first sub-task. The controller of sub-manager agent 122a may then select individual agent 102b, amongst a plurality of individual agents, based on the other second sub-task. The controller of sub-manager agent 122a may then generate a task package based on the other second sub-task, and send the task package to individual agent 102b for execution. In some embodiments, the task package includes a prompt that is compliant with individual agent 102b, and can cause individual agent 102b to generate an action to solve the other second sub-task. Sub-manager agent 122b may receive another response message from individual agent 102b when the other second sub-task is completed.

The controller of sub-manager agent 122a may receive response messages from individual agents 102a and 102b via their API's after generation the respective actions, and generate a response message based on the received response messages from individual agents 102a and 102b. The response message generated by sub-manager agent 122a may include information such as the completion status of the first sub-task, identification information of sub-manager agent 122a, individual agents 102a and 102b, and manager agent 105b. Based on the response message from sub-manager agent 122a and task instruction 104, the controller of manager agent 105 may generate a second sub-task, and select a sub-manager agent 122b, from a plurality of sub-manager agents. Manager agent 105 may repeat similar operation as with sub-manager agent 122a, with sub-manager agent 122b.

In various embodiments, the LLM (or LLM's) in an individual agent, a manager agent, or a sub-manager agent is each independently trained.

### Computer and Network Environment

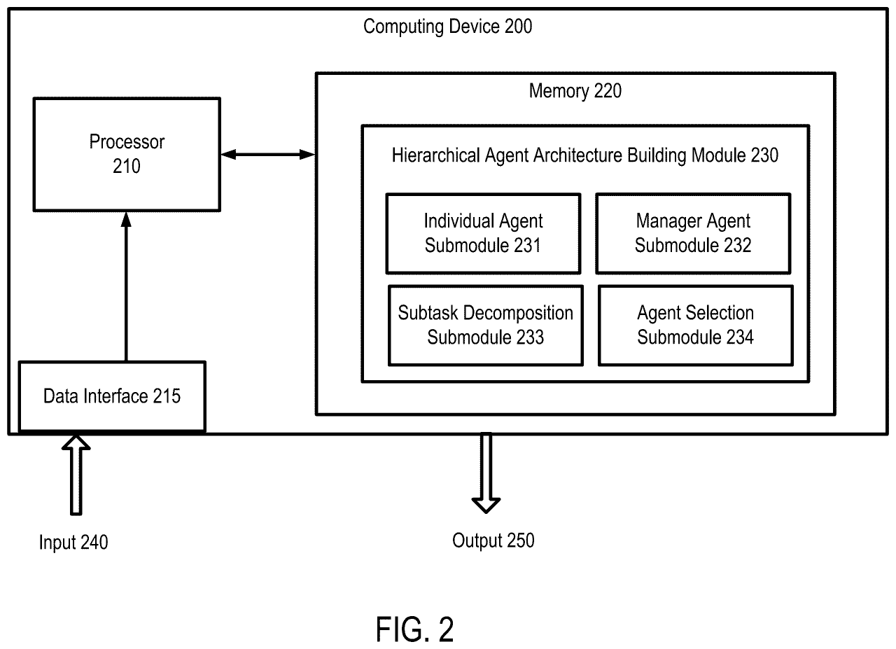

FIG. 2 is a simplified diagram illustrating a computing device implementing the building of hierarchical agent architectures described in FIGS. 1A-1E, according to one embodiment described herein. As shown in FIG. 2, computing device 200 includes a processor 210 coupled to memory 220. Operations of computing device 200 is controlled by processor 210. Although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for hierarchical agent architecture building module 230 that may be used to implement and/or emulate the systems and models, and/or to implement any of the methods described further herein. Hierarchical agent architecture building module 230 may receive input 240 such as an input training data (e.g., task instruction 104) via the data interface 215 and generate an output 250 which may be the completed task as described in task instruction 104.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as task instruction 104, from a user via the user interface.

In some embodiments, the hierarchical agent architecture building module 230 is configured to build a hierarchical agent architecture including at least a manager agent and a plurality of individual agents. The built hierarchical agent architecture may be structured to solve complex tasks. The hierarchical agent architecture building module 230 may further include an individual agent submodule 231, a manager agent submodule 232, a subtask decomposition submodule 233, and an agent selection submodule 234. It is to be noted that submodules 231-234 are for illustrative purposes only, and more than four agent submodules may be involved with hierarchical agent architecture building module 230.

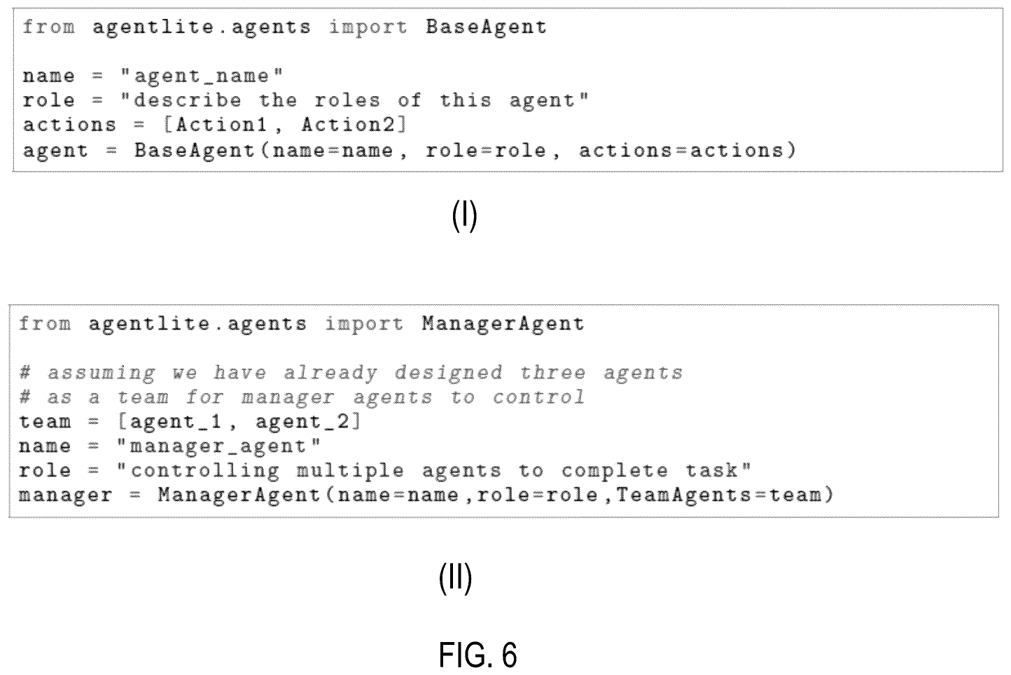

Individual agent submodule 231 may be configured to initialize an individual agent such that the individual agent is optimized for a specific action/function, and execute the functions/actions of the individual agent. Individual agent submodule 231 may be similar to individual agent 102, 102a, and 102b shown in FIGS. 1A-1E. FIG. 6 (I) shows an example of pseudo codes, by hierarchical agent architecture building module 230, to initialize an individual agent to have a name of “agent_name”, have a role of “describe the roles of this agent”, and specializes in action 1 and action 2. Individual agent submodule 231 also controls the generation of a prompt upon receiving a task package from a manager agent or a sub-manager agent, and the execution of functions/actions based on the prompt. When a sub-task is completed, individual agent submodule 231 may generate a response message having the completion status of the sub-task, as well as the identification information of the individual agent and the corresponding manager agent (or sub-manager agent).

Manager agent submodule 232 may be configured to initialize a manager agent or any sub-manager agent, if any. Manager agent submodule 232 may be similar to manager agent 105 and sub-manager agent shown in FIGS. 1C-1E. FIG. 6 (II) shows an example of pseudo codes, by hierarchical agent architecture building module 230, to initialize a manager agent to building a team including individual agent 1 and individual agent 2, have a name of “manager_agent,” and have a role of “controlling multiple agents to complete task.” Subtask decomposition submodule 233 may be configured to generate a sub-task based on an input task instruction and a response messages from execution of a previous sub-task. Agent selection submodule 231 may select an individual agent based on the sub-task, and build a connection with the individual agent via an API. In some embodiments, manager agent submodule 232, subtask decomposition submodule 233, and agent selection submodule 234 coordinate to complete the functions of a manager agent. The manager agent may also be configured to generate a task package corresponding to the sub-task, send the task package to the individual agent for execution, and receive a response message/feedback from the individual agent. Subtask decomposition submodule 233 may then determine another sub-task based on the response message and the input task instruction, and agent selection submodule 234 may select another individual agent based on the other sub-task. In some embodiments, subtask decomposition submodule 233 is initialized to generate a sub-task based on the input task instruction and a response message/feedback, and agent selection submodule 234 is initialized to select a sub-manager agent based on the sub-task.

In some embodiments, manager agent submodule 232 may be configured to initialize a sub-manager agent. The sub-manager agent may receive a sub-task from a manager agent, and agent selection submodule 234 may select an individual agent based on the sub-task. The sub-manager agent may also generate a response message to the manager agent based on one or more response messages it receives from a plurality of individual agents to inform the manager agent information such as the completion status of the sub-task, as well as identification information of the sub-manager agent, the individual agents, and the manager agent.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

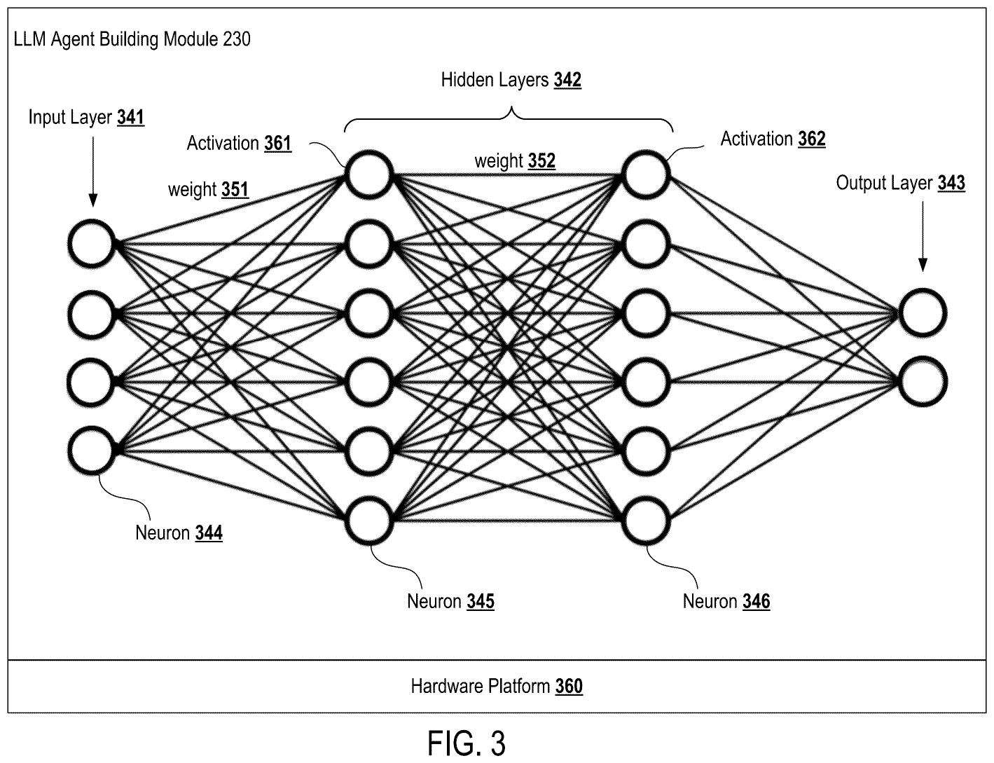

FIG. 3 is a simplified diagram illustrating the neural network structure implementing the hierarchical agent architecture building module 230 described in FIG. 2, according to some embodiments. In some embodiments, the hierarchical agent architecture building module 230 and/or one or more of its submodules 231-234 may be implemented at least partially via an artificial neural network structure shown in FIG. 3. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 240 in FIG. 2), such as a task instruction. The number of nodes (neurons) in the input layer 341 may be determined by the dimensionality of the input data (e.g., the length of a vector of the task instruction). Each node in the input layer represents a feature or attribute of the input.

The hidden layers 342 are intermediate layers between the input and output layers of a neural network. It is noted that two hidden layers 342 are shown in FIG. 3 for illustrative purposes only, and any number of hidden layers may be utilized in a neural network structure. Hidden layers 342 may extract and transform the input data through a series of weighted computations and activation functions.

For example, as discussed in FIG. 2, the hierarchical agent architecture building module 230 receives an input 240 of a task instruction and transforms the input into an output 250 of the completed task described in the task instruction. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the hierarchical agent architecture building module 230 and/or one or more of its submodules 231-234 may comprise the transformative neural network structure of layers of neurons, and weights and activation functions describing the non-linear transformation at each neuron. Such a neural network structure is often implemented on one or more hardware processors 210, such as a graphics processing unit (GPU). An example neural network may be GPT-3.5-turbo, GPT-4, and/or the like.

In one embodiment, the hierarchical agent architecture building module 230 and its submodules 231-234 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represent a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the hierarchical agent architecture building module 230 and its submodules 231-234 may be implemented by hardware, software and/or a combination thereof. For example, the hierarchical agent architecture building module 230 and its submodules 231-234 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In one embodiment, the neural network based hierarchical agent architecture building module 230 and one or more of its submodules 231-234 may be trained by iteratively updating the underlying parameters (e.g., weights 351, 352, etc., bias parameters and/or coefficients in the activation functions 361, 362 associated with neurons) of the neural network based on the loss. For example, during forward propagation, the training data such as a task instruction are fed into the neural network. The data flows through the network's layers 341, 342, with each layer performing computations based on its weights, biases, and activation functions until the output layer 343 produces the network's output 250. In some embodiments, output layer 343 produces an intermediate output on which the network's output 250 is based.

The output generated by the output layer 343 is compared to the expected output (e.g., a “ground-truth”) from the training data, to compute a loss function that measures the discrepancy between the predicted output and the expected output. For example, the loss function may be cross entropy, MMSE, etc. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based hierarchical agent architecture building module 230 and one or more of its submodules 231-234 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

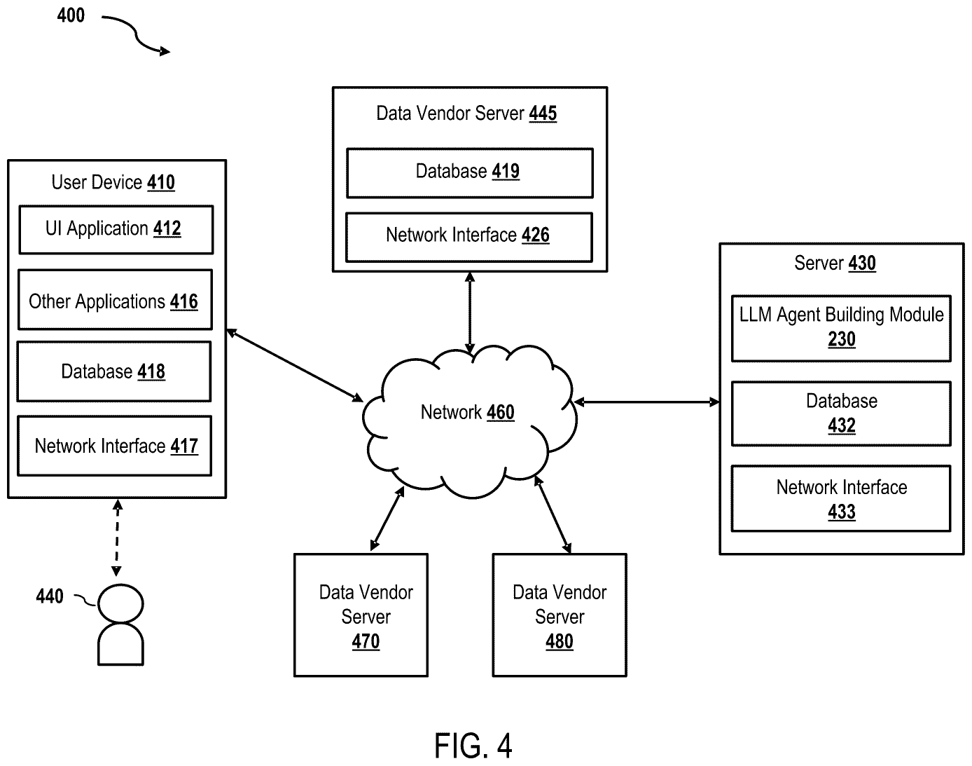

In one embodiment, hierarchical agent architecture building module 230 and its submodules 231-234 may be housed at a centralized server (e.g., computing device 200) or one or more distributed servers. For example, one or more of hierarchical agent architecture building module 230 and its submodules 231-234 may be housed at an external servers. The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as a user asking hierarchical agent architecture building module 230 to perform a complex math problem.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in autonomous agents.

FIG. 4 is a simplified block diagram of a networked system 400 suitable for implementing the hierarchical agent architecture building framework described in FIGS. 1A-1E and 2 and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating the completion of a task described in a task instruction from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the hierarchical agent architecture building module 230 (e.g., an agent) at server 430. In at least one embodiment, a user operating user device 410 may enter a user utterance, e.g., via text or audio input, such as a question, uploading a document, and/or the like via the UI application 412. Such user utterance may be sent to server 430, at which hierarchical agent architecture building module 230 may generate a response via the process described in FIGS. 1A-1E. The hierarchical agent architecture building module 230 may thus cause a display of the completion of the task at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view the completion of the task described in the task instruction.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including task instructions, prompts, task completion results, etc. to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the hierarchical agent architecture building module 230 and its submodules described in FIG. 2A. In some implementations, hierarchical agent architecture building module 230 may receive data from database 419 at the data vendor server 445 via the network 460 to generate response messages, completion results of tasks. The generated completion results may also be sent to the user device 410 for review by the user 440 via the network 460.

The database 432 may be stored in a transitory and/or non-transitory memory of the server 430. In one implementation, the database 432 may store data obtained from the data vendor server 445. In one implementation, the database 432 may store parameters of the hierarchical agent architecture building module 230. In one implementation, the database 432 may store previously generated response messages, observations, actions, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

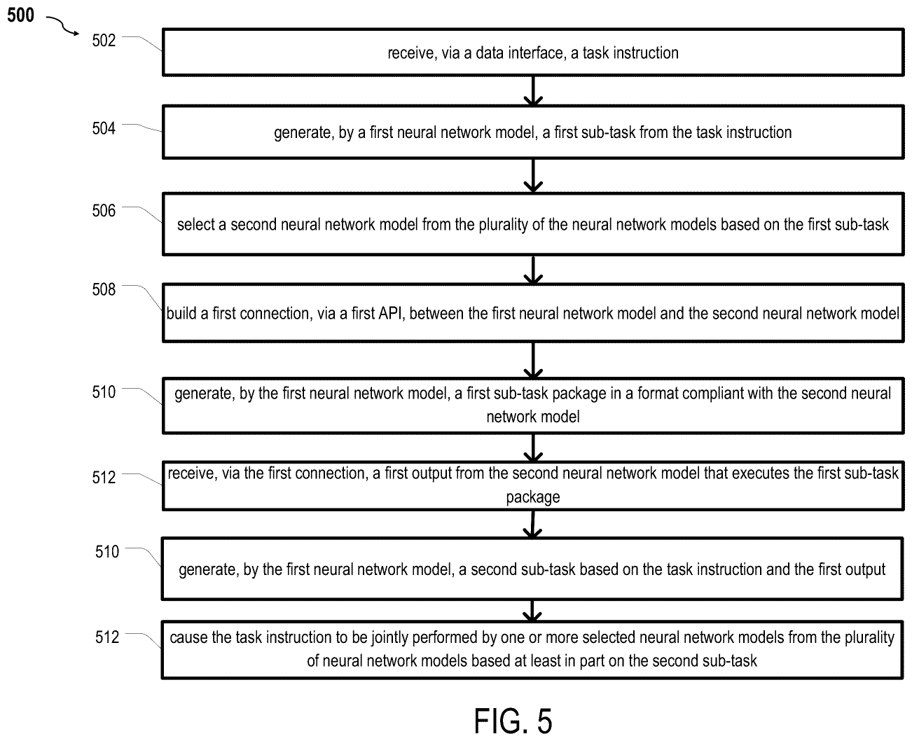

FIG. 5 is an example logic flow diagram illustrating a method of building a hierarchical agent architecture based on the framework shown in FIGS. 1A-1E, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operations of the hierarchical agent architecture building module 230 (e.g., FIGS. 2 and 3) that performs the building of a hierarchical agent architecture.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a manager agent (e.g., 105) receives, via a data interface (e.g., 215), a task instruction (e.g., 104).

At step 504, the manager agent generates, by a first neural network model (e.g., LLM 1 and/or LLM 2), a first sub-task from the task instruction.

At step 506, the manager agent selects a second neural network model (e.g., 102a, 110) from the plurality of the neural network models based on the first sub-task.

At step 508, the manager agent builds a first connection, via a first application programming interface (API), between the first neural network model and the second neural network model.

At step 510, the manager agent generates, by the first neural network model, a first sub-task package (e.g., task package 1) in a format compliant with the second neural network model.

In some embodiments, the first sub-task package includes a first prompt compliant with the second neural network model, instructing the second neural network model to perform the first sub-task. The first output includes one or more of a completion status corresponding to the first sub-task, identification information for the first neural network model, identification information for the second neural network model. In some embodiments, the first output includes a response template for the first neural network model to populate a response and/or an output of the first sub-task.

At step 512, the manager agent receives, via the first connection, a first output (e.g., 115a) from the second neural network model that executes the first sub-task package.

At step 514, the manager agent generates, by the first neural network model, a second sub-task based on the task instruction and the first output.

At step 516, the manager agent causes the task instruction to be jointly performed by one or more selected neural network models (e.g., 102a, 102b, 110) from the plurality of neural network models based at least in part on the second sub-task.

In some embodiments, the causing the task instruction to be jointly performed further includes: selecting a third neural network model from the plurality of neural network models based on the second sub-task; building a second connection, via a second API between the first neural network model and the third neural network model; generating, by the first neural network model, a second sub-task package in a format compliant with the third neural network model; and receiving, via the second connection, a second output from the third neural network model that executes the second sub-task package.

In some embodiments, method 500 further includes: receiving, by one of the first neural network model or the second neural network model, a human instruction; and generating, by the first neural network model, the first sub-task based on the task instruction and the human instruction.

In some embodiments, method 500 further includes: a fourth neural network model communicatively coupled to the first neural network model via a third connection based on a third API; and generating, by the first neural network or the fourth network, the first sub-task package. The generating, jointly by the first neural network and the fourth neural network, the first sub-task package may include: generating, by the first neural network model, a first part of the task from the task instruction; generating, by the fourth neural network model, a second part of the task from the task instruction; assembling, by the first neural network model or the second neural network model, the first part and the second part of the task instruction to form the first sub-task; and selecting, by the first neural network model or the second neural network model, the second neural network model from the plurality of the neural network models based on the first sub-task.

In some embodiments, the generating, jointly by the first neural network and the fourth neural network, the first sub-task package comprises: generating, by the first neural network model, an initial first sub-task from the task instruction; receiving, by the fourth neural network model, the initial first sub-task via the third connection; and generating, by the fourth neural network model, the first sub-task from the initial first sub-task.

In some embodiments, method 500, further includes: selecting a fifth neural network model from the plurality of the neural network models based on the first sub-task; building a fourth connection, via a fourth API, between the first neural network model and the fifth neural network model; transmitting, by the first neural network model, the first sub-task to the fifth neural network model via the fourth API to cause the fifth neural network model to generate another first sub-task and select a sixth neural network from the plurality of the neural network models based on the other first sub-task; receiving, via at least the fourth connection, another first output from the sixth neural network model that executes another first sub-task package corresponding to the other first sub-task; and generating, by the fifth neural network model, another second sub-task based on the first sub-task and the other first output.

In some embodiments, the first neural network and the second neural network are each independently trained.

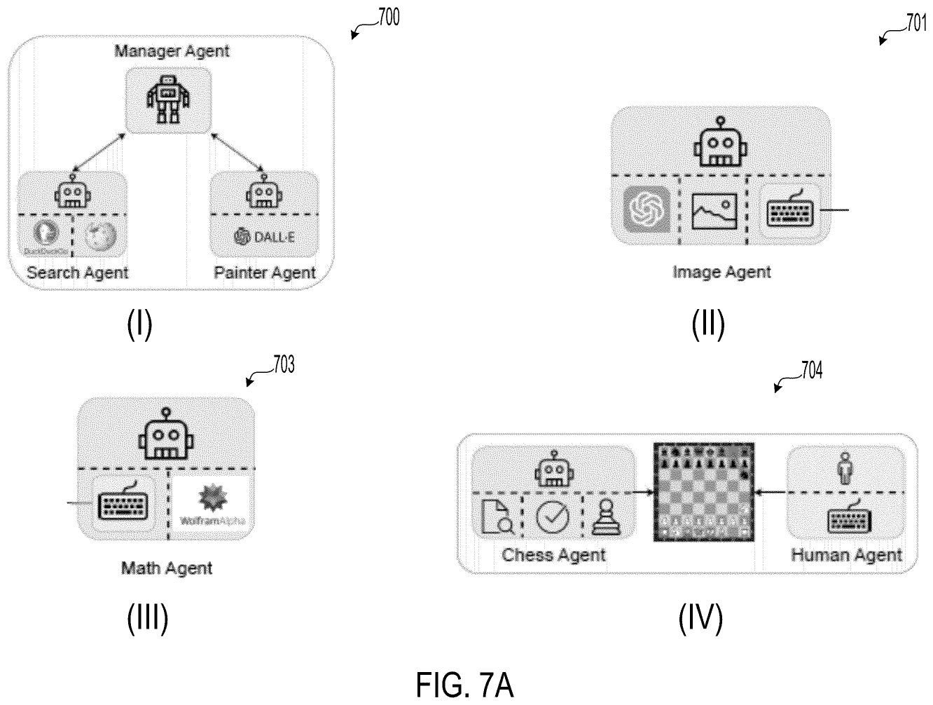

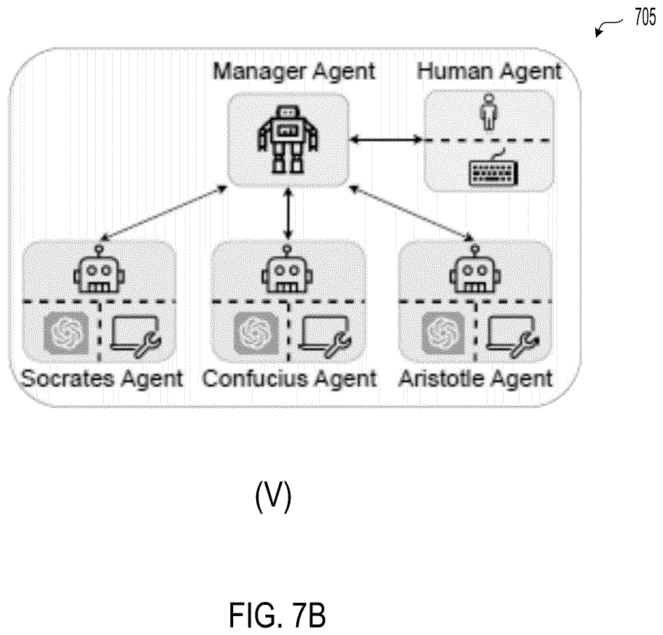

FIGS. 7A and 7B illustrates different applications of hierarchical agent architectures, according to some embodiments.

FIG. 7A (I) illustrate an Online Painter application 700 with the use of a manager agent and two individual agents. Given any object, Online Painter application 700 is able to search relevant visual features online first and then paint an image of the object based on the detailed features. The Online Painter application 700 is completed by three agents (Manager Agent, Search Agent, Painter Agent). In some embodiments, Search Agent and Painter Agent are each an individual agent. A search action and paint action are added into search agent and painter agent, respectively. The Search Agent may include two actions to use for collecting information. As an example, the DuchSearch action may collect online information via a DuckDuckGo API based on the query, and the WikipediaSearch action may search for relevant information on Wikipedia. These two actions endow the Search Agent with the ability to obtain information about the painted object. The Painter Agent have one DALLE action to paint the picture given the description from DuchSearch action and WikipediaSearch action. Then a Manager Agent is used to control them for online painting tasks that Manager Agent receives tasks directly with the Task Package and dismantles the task to different steps for its team members consisting of Search Agent and Painter Agent.

FIG. 7A (II) illustrates an Interactive Image Understanding application 701. Interactive Image Understanding application 701 is a multi-modality application with human-in-the-loop instructions. Interactive Image Understanding application 701 may include an image agent (e.g., an individual agent). Given an image, the application can provide answers to the questions from the human based on the image. Humans can give questions for several rounds to the application with natural languages such as “What is in the image?” “What is the color of the bridge?” etc. The application can also be terminated with ending instructions from humans such as “I good for today, have a great weekend,” as real-life conversations. The ImageDisplay action shows the image to a human user and ImageQuery action answers questions based on the image. The ImageQuery action is backended by the GPT-4-visionpreview API. Empowered by the HumanInput action, the Image Agent is able to acquire and follow instructions from humans.

FIG. 7A (III) shows a Math Problem Solving application 703. Math Problem Solving application 703 is an application built with a Math Agent (e.g., an induvial agent). The Math Agent receives and solves a math problem from the human input. Human inputs can be either direct math equations as “75×34+12=” or descriptions of the problem as “What is the result of 75 multiplied by 34 and then plus 12?” A Math Copilot Agent with HumanInput and WolframAlphaSolver actions is developed. The Math Agent acquires math questions from humans with HumanInput action, and then solve the problem with WolframAlphaSolver action. It is integrated with the WolframAlpha API, which is able to solve a wide range of math problems from basic operations to equation solving and calculus.

FIG. 7A (IV) illustrates a Chess Game application 704. Chess Game application 704 is a practical application to enable playing the Chess game against Large Language models. It takes turns to ask the Chess Agent and Human to move a step on the Chessboard. As the workflow can be easily managed, it is not needed to build a Manager Agent. It involves one Human Agent (or human) collecting input from the keyboard and one Chess Agent that is able to view the board, make analysis, and move the chess. As an example, Chess Agent has 5 actions to play chess with a human. Think and Finish action are internally supported for reasoning and finish. Besides, 3 more actions are further added to the Chess Agent. For example, BoardView action obtains current board's Forsyth-Edwards Notation (FEN), which is a standard notation to describe the positions of chess, and display the current board. LegalMoves action obtains current available moves of the board. Chess Agent finds available moves with this action. BoardMove action moves the chess on the board. Agent can be on both side of the Chess Board (e.g., another Chess Agent replaces the human), which further supports Agent-Agent Chess game.

FIG. 7B (V) illustrates a Philosophers Chatting application 705, configured to mimic Philosopher's thoughts including, for example, Socrates, Confucius, and Aristotle. Philosophers Chatting application 705 may be a multi-agent framework, e.g., a Manager Agent with its team members as Human Agent, Socrates Agent, Confucius Agent, and Aristotle Agent. Each time Human can give one philosophy question to the Manager Agent such as “What should we pursue during our life?”. After the Manager Agent receives the question, it asks the Socrates/Confucius/Aristotle agents for their opinions one by one and summarizes the results to answer the question. The Manager Agent is instantiated through the integration of four distinct agents into a team. Manager Agent orchestrates discussion flow, which encompasses identification of relevant questions, forwarding of these inquiries to appropriate agent, and summarizing discussion. This structured approach facilitates an effective exchange of information.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for building a hierarchical structure of a plurality of neural network models for performing a task, the method comprising:
receiving, via a data interface, a task instruction;
generating, by a first neural network model, a first sub-task from the task instruction;
selecting a second neural network model from the plurality of the neural network models based on the first sub-task;
building a first connection, via a first application programming interface (API), between the first neural network model and the second neural network model;
generating, by the first neural network model, a first sub-task package in a format compliant with the second neural network model;
receiving, via the first connection, a first output from the second neural network model that executes the first sub-task package;
generating, by the first neural network model, a second sub-task based on the task instruction and the first output; and
causing the task instruction to be jointly performed by one or more selected neural network models from the plurality of neural network models based at least in part on the second sub-task.

2. The method of claim 1, wherein the causing the task instruction to be jointly performed further comprises:
selecting a third neural network model from the plurality of neural network models based on the second sub-task;
building a second connection, via a second API between the first neural network model and the third neural network model;
generating, by the first neural network model, a second sub-task package in a format compliant with the third neural network model; and
receiving, via the second connection, a second output from the third neural network model that executes the second sub-task package.

3. The method of claim 1, wherein the first sub-task package comprises a first prompt compliant with the second neural network model, instructing the second neural network model to perform the first sub-task.

4. The method of claim 1, wherein the first output comprises one or more of a completion status corresponding to the first sub-task, identification information for the first neural network model, or identification information for the second neural network model.

5. The method of claim 1, further comprising:
receiving, by one of the first neural network model or the second neural network model, a human instruction; and
generating, by the first neural network model, the first sub-task based on the task instruction and the human instruction.

6. The method of claim 1, further comprising:
a fourth neural network model communicatively coupled to the first neural network model via a third connection based on a third API; and
generating, by the first neural network or the fourth network, the first sub-task package.

7. The method of claim 6, wherein the generating, jointly by the first neural network and the fourth neural network, the first sub-task package comprises:
generating, by the first neural network model, an initial first sub-task from the task instruction;
receiving, by the fourth neural network model, the initial first sub-task via the third connection; and
generating, by the fourth neural network model, the first sub-task from the initial first sub-task.

8. The method of claim 6, wherein the generating, jointly by the first neural network and the fourth neural network, the first sub-task package comprises:
generating, by the first neural network model, a first part of the task from the task instruction;
generating, by the fourth neural network model, a second part of the task from the task instruction;
assembling, by the first neural network model or the second neural network model, the first part and the second part of the task instruction to form the first sub-task; and
selecting, by the first neural network model or the second neural network model, the second neural network model from the plurality of the neural network models based on the first sub-task.

9. The method of claim 1, further comprising:
selecting a fifth neural network model from the plurality of the neural network models based on the first sub-task;
building a fourth connection, via a fourth API, between the first neural network model and the fifth neural network model;
transmitting, by the first neural network model, the first sub-task to the fifth neural network model via the fourth API to cause the fifth neural network model to generate another first sub-task and select a sixth neural network from the plurality of the neural network models based on the other first sub-task;
receiving, via at least the fourth connection, another first output from the sixth neural network model that executes another first sub-task package corresponding to the other first sub-task; and
generating, by the fifth neural network model, another second sub-task based on the first sub-task and the other first output.

10. The method of claim 1, wherein the first neural network and the second neural network are each independently trained.

11. A system for building a hierarchical structure of a plurality of neural network models for performing a task, the system comprising:
a memory that stores the plurality of neural network models and a plurality of processor executable instructions;
a communication interface that receives a task instruction; and
one or more hardware processors that read and execute the plurality of processor-executable instructions from the memory to perform operations comprising:
generating, by a first neural network model, a first sub-task from the task instruction;
selecting a second neural network model from the plurality of the neural network models based on the first sub-task;
building a first connection, via a first application programming interface (API), between the first neural network model and the second neural network model;
generating, by the first neural network model, a first sub-task package in a format compliant with the second neural network model;
receiving, via the first connection, a first output from the second neural network model that executes the first sub-task package;
generating, by the first neural network model, a second sub-task based on the task instruction and the first output; and
causing the task instruction to be jointly performed by one or more selected neural network models from the plurality of neural network models based at least in part on the second sub-task.

12. The system of claim 11, wherein the causing the task instruction to be jointly performed further comprises:
selecting a third neural network model from the plurality of neural network models based on the second sub-task;
building a second connection, via a second API between the first neural network model and the third neural network model;
generating, by the first neural network model, a second sub-task package in a format compliant with the third neural network model; and
receiving, via the second connection, a second output from the third neural network model that executes the second sub-task package.

13. The system of claim 11, wherein the first sub-task package comprises a first prompt compliant with the second neural network model, instructing the second neural network model to perform the first sub-task.

14. The system of claim 11, wherein the first output comprises one or more of a completion status corresponding to the first sub-task, identification information for the first neural network model, or identification information for the second neural network model.

15. The system of claim 11, wherein the operations further comprise:
receiving, by one of the first neural network model or the second neural network model, a human instruction; and
generating, by the first neural network model, the first sub-task based on the task instruction and the human instruction.

16. The system of claim 11, wherein the operations further comprise:
a fourth neural network model communicatively coupled to the first neural network model via a third connection based on a third API; and
generating, by the first neural network or the fourth network, the first sub-task package.

17. The system of claim 16, wherein the generating, jointly by the first neural network and the fourth neural network, the first sub-task package comprises:
generating, by the first neural network model, an initial first sub-task from the task instruction;
receiving, by the fourth neural network model, the initial first sub-task via the third connection; and
generating, by the fourth neural network model, the first sub-task from the initial first sub-task.

18. The system of claim 16, wherein the generating, jointly by the first neural network and the fourth neural network, the first sub-task package comprises:
generating, by the first neural network model, a first part of the task from the task instruction;
generating, by the fourth neural network model, a second part of the task from the task instruction;
assembling, by the first neural network model or the second neural network model, the first part and the second part of the task instruction to form the first sub-task; and
selecting, by the first neural network model or the second neural network model, the second neural network model from the plurality of the neural network models based on the first sub-task.

19. The system of claim 11, wherein the operations further comprise:
selecting a fifth neural network model from the plurality of the neural network models based on the first sub-task;
building a fourth connection, via a fourth API, between the first neural network model and the fifth neural network model;
transmitting, by the first neural network model, the first sub-task to the fifth neural network model via the fourth API to cause the fifth neural network model to generate another first sub-task and select a sixth neural network from the plurality of the neural network models based on the other first sub-task;
receiving, via at least the fourth connection, another first output from the sixth neural network model that executes another first sub-task package corresponding to the other first sub-task; and
generating, by the fifth neural network model, another second sub-task based on the first sub-task and the other first output.

20. A non-transitory machine-readable medium comprising a plurality of machine-executable instructions which, when executed by one or more processors, are adapted to cause the one or more processors to perform operations comprising:
receiving, via a data interface, a task instruction;
generating, by a first neural network model, a first sub-task from the task instruction;
selecting a second neural network model from the plurality of the neural network models based on the first sub-task;
building a first connection, via a first application programming interface (API), between the first neural network model and the second neural network model;
generating, by the first neural network model, a first sub-task package in a format compliant with the second neural network model;
receiving, via the first connection, a first output from the second neural network model that executes the first sub-task package;
generating, by the first neural network model, a second sub-task based on the task instruction and the first output; and
causing the task instruction to be jointly performed by one or more selected neural network models from the plurality of neural network models based at least in part on the second sub-task.
